(19) United States
(12) Patent Application Publication
(10) Pub. No.: US 2014/0320624 A1
(43) Pub. Date: Oct. 30, 2014

(54) ELECTRONIC DEVICE AND METHOD FOR REGULATING IMAGES DISPLAYED ON DISPLAY SCREEN

(71) Applicant: Hon Hai Precision Industry Co., Ltd., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: Hon Hai Precision Industry Co., Ltd., New Taipei (TW)

(21) Appl. No.: 14/220,160

(22) Filed: Mar. 20, 2014

(30) Foreign Application Priority Data
Apr. 29, 2013 (TW) 102115247

(51) Int. Cl. H04N 21/4223; G06K 9/00; H04N 5/262; H04N 21/422; H04N 5/64

(52) U.S. Cl. CPC H04N 21/4223; H04N 21/42204; H04N 5/64; H04N 5/2628; G06K 9/00604; G06K 9/00228
USPC 348/78

(57) ABSTRACT

In a method for regulating images displayed on a display screen of an electronic device, the electronic device includes an image capturing unit and driving unit. An adjustment mode of the display screen is preset through a user setting interface displayed on the display screen, and the image capturing unit captures an image of a scene in front of the display screen when the user presses a regulation button of a remote controller. The method analyzes a viewing angle and a viewing direction of the user when the user views the display screen, and determines a regulating angle and a regulating direction related to the display screen according to the viewing angle and the viewing direction. The display screen or the image displayed on the display screen is rotated through the regulating angle and the regulating direction according to the adjustment mode.

### BACKGROUND

1. Technical Field

Embodiments of the present disclosure relate to image displaying systems and methods, and particularly to an electronic device and a method for regulating images displayed on a display screen of the electronic device.

2. Description of Related Art

Images are often displayed on a display screen of an electronic device (e.g., smart television) with an unchanged orientation (e.g., a horizontal orientation). A viewing angle cannot be changed according to a movement of a user's head. For example, when the user lies on a sofa, the viewing angle is not consistent with a display angle of the images on the smart television, which may result in eye strain after watching the TV for an extended time. Therefore, a more efficient method for regulating a display screen of an electronic device is desired.

### BRIEF DESCRIPTION OF THE DRAWINGS

FIG. 1 is a block diagram of one embodiment of an electronic device comprising a display regulating system.

FIG. 2 is a schematic diagram illustrating a front and back panel of the electronic device.

FIG. 3 is a flowchart of one embodiment of a method for regulating images displayed on a display screen of the electronic device.

FIG. 4 shows a schematic diagram illustrating one embodiment of setting an initial position of the user's head and an adjustment mode through a user setting interface displayed on the display screen.

FIG. 5 is a schematic diagram illustrating one embodiment of capturing an image of a scene in front of the display screen.

FIG. 6 is a schematic diagram illustrating one embodiment of detecting a position of the user's eyeballs from the scene image.

FIG. 7 shows a schematic diagram illustrating one embodiment of viewing the display screen with different viewing angles of the user.

FIG. 8 is a schematic diagram illustrating one embodiment of adjusting a physical orientation of the display screen.

FIG. 9 is a schematic diagram illustrating one embodiment of adjusting a display orientation of the displayed image on the display screen.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Some non-limiting examples of a non-transitory computer-readable medium comprise CDs, DVDs, flash memory, and hard disk drives.

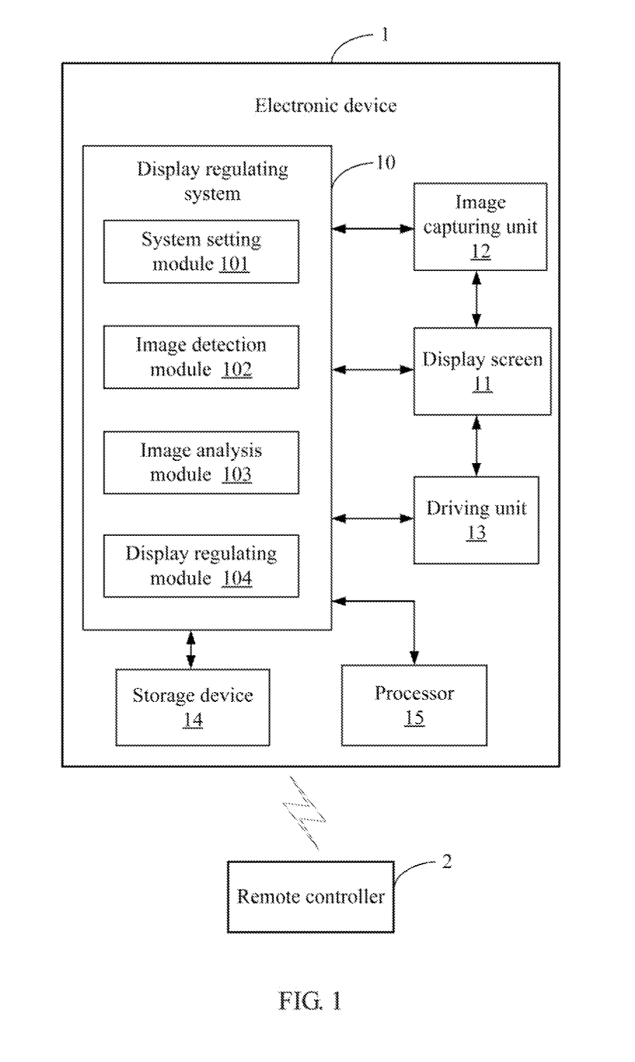

FIG. 1 is a block diagram of one embodiment of an electronic device 1 comprising a display regulating system 10. In the embodiment, the electronic device 1 further includes, but is not limited to, a display screen 11, an image capturing unit 12, a driving unit 13, a storage device 14, and at least one processor 15. The electronic device 1 may be a smart television (TV) that is operated by a remote controller 2, and the display screen 11 may be a liquid crystal display (LCD) screen of the smart TV. The display regulating system 10 can rotate the display screen 11 or can rotate an image displayed on the display screen 11 (hereinafter “displayed image”) according to movements of a user's head. In one embodiment, the display regulating system 10 comprises computerized instructions in the form of one or more computer-readable programs stored in the storage device 14 and executed by the at least one processor 15. FIG. 1 is only one example of the electronic device 1, other examples may comprise more or fewer components than those shown in the embodiment, or have a different configuration of the various components.

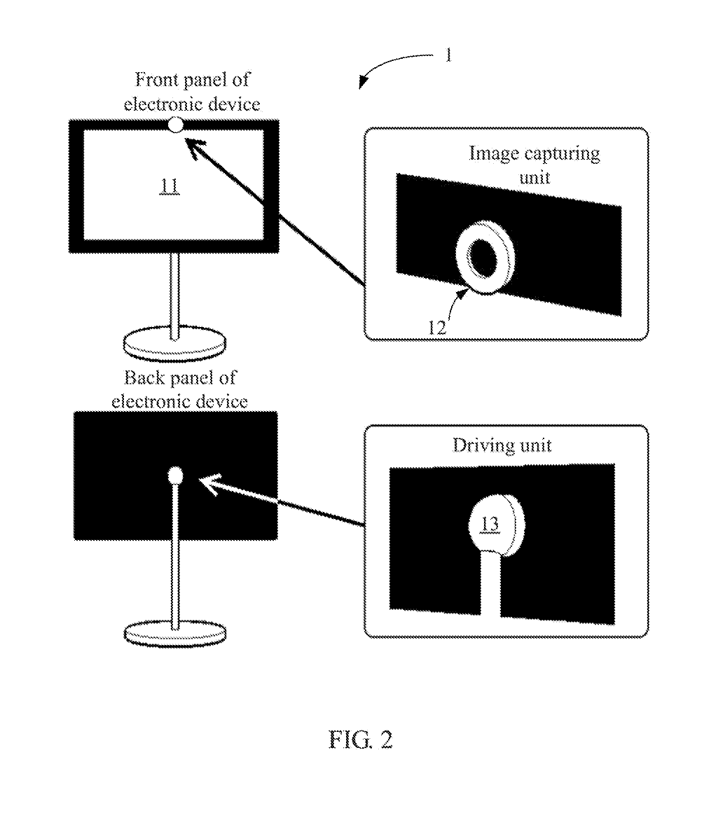

FIG. 2 shows a schematic diagram illustrating the front and back panel of the electronic device 1. In the embodiment, the display screen 11 is equipped on the front of the electronic device 1, and displays images for users to view. The image capturing unit 12 can be a camera that is positioned on a center of a top edge of a front panel of the display screen 11, and captures an image of a scene in front of the display screen 11 (hereinafter “scene image”). The driving unit 13 is positioned on the back (or on the bottom) of the electronic device 1, the driving unit 13 can be a drive motor that controls the display screen 11 to automatically rotate the display screen 11 according to the movements of the user's head.

In one embodiment, the storage device 14 can be an internal storage system, such as a flash memory, a random access memory (RAM) for temporary storage of information, and/or a read-only memory (ROM) for permanent storage of information. The storage device 14 can also be an external storage system, such as an external hard disk, a storage card, or a data storage medium. The at least one processor 15 can be a central processing unit (CPU), a microprocessor, or other data processor chip that performs various functions of the electronic device 1.

Referring back to FIG. 1, in the embodiment, the display regulating system 10 comprises a system setting module 101, an image detection module 102, an image analysis module 103, and a display regulating module 104. The modules 101-104 can comprise computerized instructions in the form of one or more computer-readable programs that are stored in a non-transitory computer-readable medium (such as the storage device 14) and executed by the at least one processor 15 of the electronic device 1. A description of each module is given in the following paragraphs.

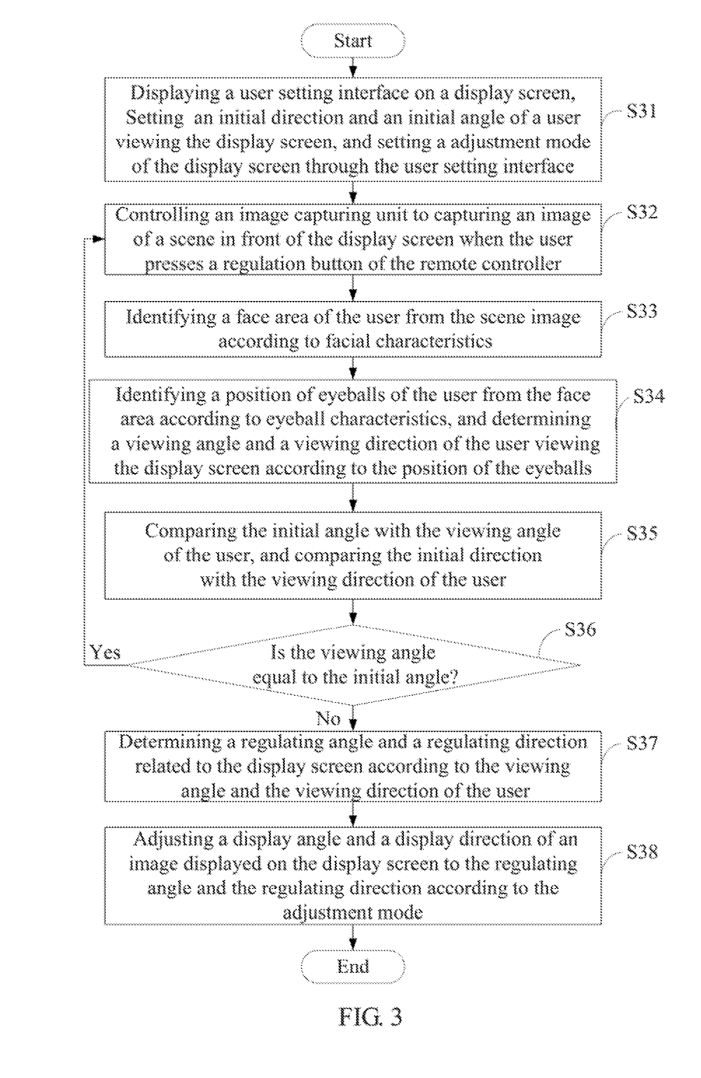

FIG. 3 is a flowchart of one embodiment of a method for regulating images displayed on the display screen 11 of the electronic device 1. In one embodiment, the method is performed by execution of computer-readable software program codes or instructions by the at least one processor 15 of the electronic device 1. Depending on the embodiment, additional steps can be added, other steps can be removed, and the ordering of the steps can be changed.

In step S31, the system setting module 101 displays a user setting interface on the display screen 11 when the user presses a menu button of the remote controller 2, sets an initial direction and an initial angle of the user views related to the display screen 11 (i.e., an initial position of the user's eyes), and sets an adjustment mode of the display screen 11 for adjusting images displayed on the display screen 11 through the user setting interface. In one embodiment, the adjustment mode includes a hardware adjustment mode for adjusting a physical orientation of the display screen 11, and a software adjustment mode for adjusting a display orientation of the displayed images on the display screen 11.

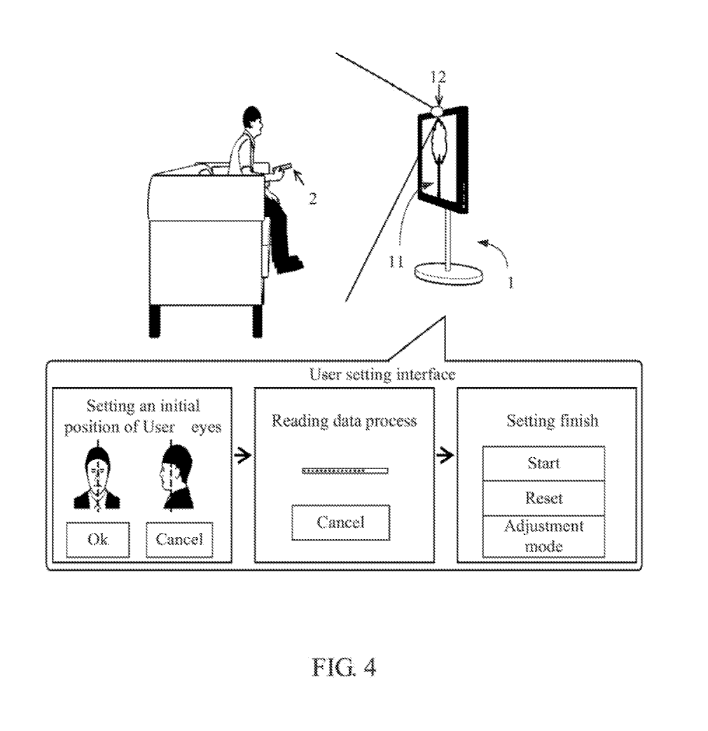

FIG. 4 shows a schematic diagram illustrating one embodiment of setting the initial position of the user's head and the adjustment mode through the user setting interface. The system setting module 101 sets an initial position of the user′ head and an adjustment mode of the display screen 11 in response to the user input on the user setting interface. When the user presses a confirm button (e.g., an “OK” button) on the remote controller 2, the system setting module 101 stores information of the initial position of the user's head and the adjustment mode into the storage device 14 of the electronic device 1. In one embodiment, the initial position of the user's head corresponds to an initial angle and an initial direction of the eyes of a user related to the display screen 11 when a viewing angle of the user is consistent with a display angle of the image displayed on the display screen 11.

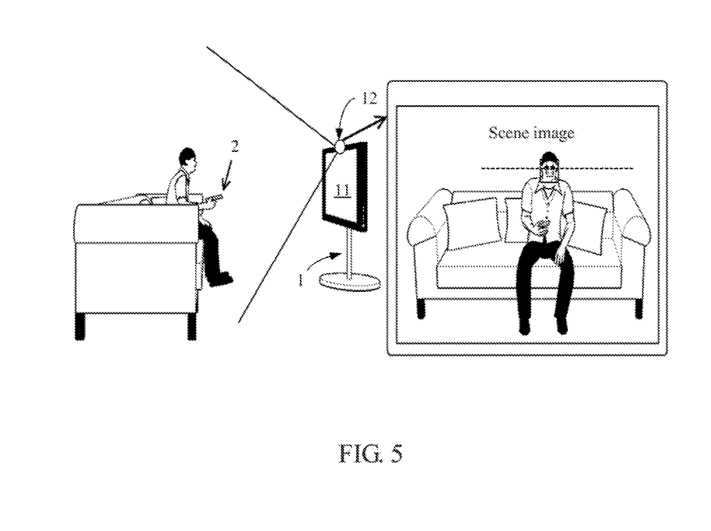

In step S32, the image detection module 102 controls the image capturing unit 12 to capture an image of a scene in front of the display screen 11 when the user presses a regulation button of the remote controller 2. Referring to FIG. 5, the scene image is captured by the image capturing unit 12 when the regulation button of the remote controller 2 is pressed by the user. The scene image includes a person image of the user who is viewing images displayed on the display screen 11.

In step S33, the image detection module 102 identifies a face area of the user from the scene image according to facial characteristics of human. In the embodiment, the facial characteristics of human may include eyes character data, nose character data and mouth character data. The image detection module 102 marks the detected face area using a special shape, such as a rectangle shape, or a circle shape.

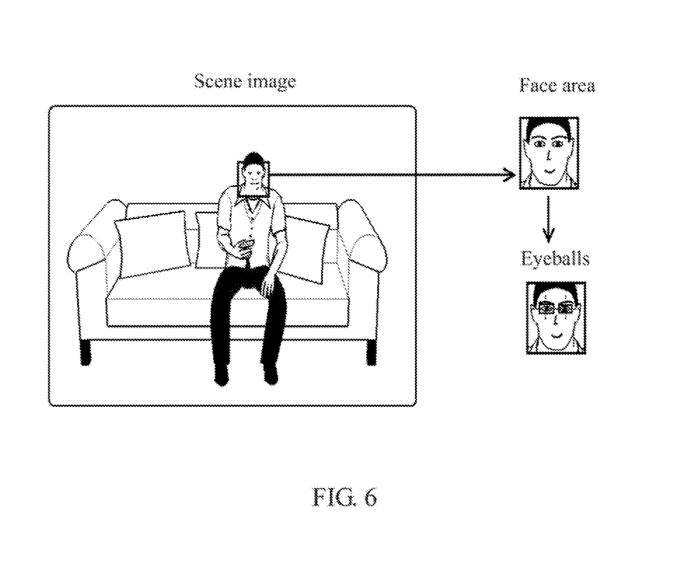

In step S34, the image detection module 102 identifies a position of eyeballs of the user (hereinafter the user's eyeballs) from the face area of the user according to eyeball characteristics of human, and determines a viewing angle and a viewing direction of the user viewing the display screen 11 according to the position of the eyeballs. Referring to FIG. 6, the face area of the user is detected from the scene image according to the facial characteristics, and the position of the user's eyeballs is detected from the face area of the user according to the eyeball characteristics.

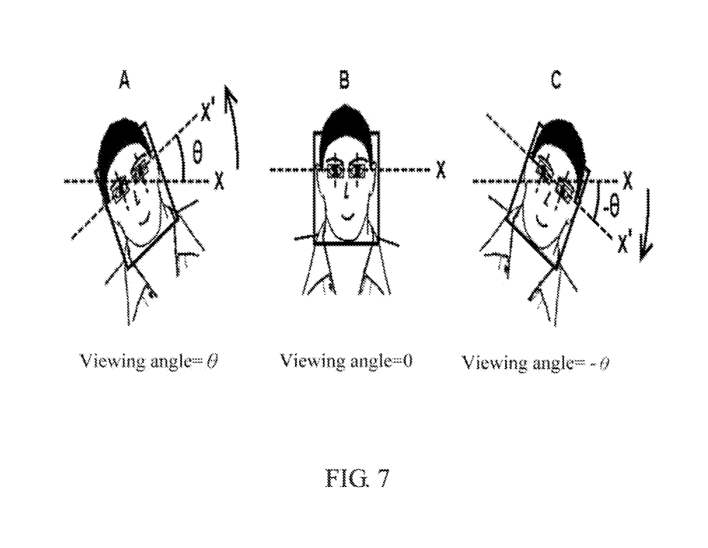

In step S35, the image analysis module 103 compares the initial angle with the viewing angle of the user, and compares the initial direction with the viewing direction of the user. FIG. 7 shows a schematic diagram illustrating one embodiment of viewing the display screen 11 with different viewing angles of the user. For example, if the user turns his or her head up or right with an angle θ, the viewing angle of the user is denoted by a positive angle (i.e., +θ). If the user turns his or her head down or left with an angle θ, the viewing angle of the user is denoted by a negative angle (i.e., −θ).

In step S36, the image analysis module 103 determines whether the viewing angle of the user is equal to the initial angle. If the viewing angle of the user is equal to the initial angle, the process goes back to step S32. Otherwise, if the viewing angle of the user is not equal to the initial angle, step S37 is implemented.

In step S37, the display regulating module 104 determines a regulating angle and a regulating direction related to the display screen 11 according to the viewing angle and the viewing direction of the user. In the embodiment, the regulating angle equals to the viewing angle of the user, and the regulating direction corresponds to the viewing direction of the user.

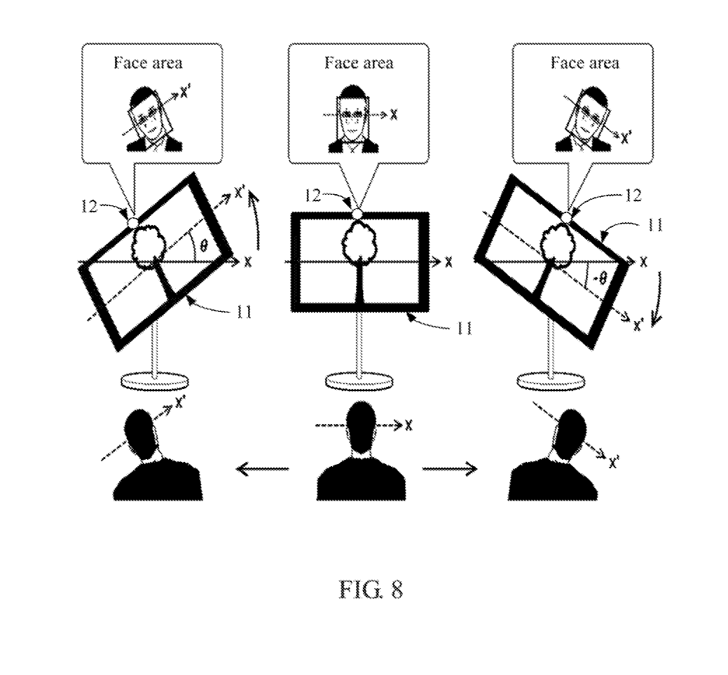

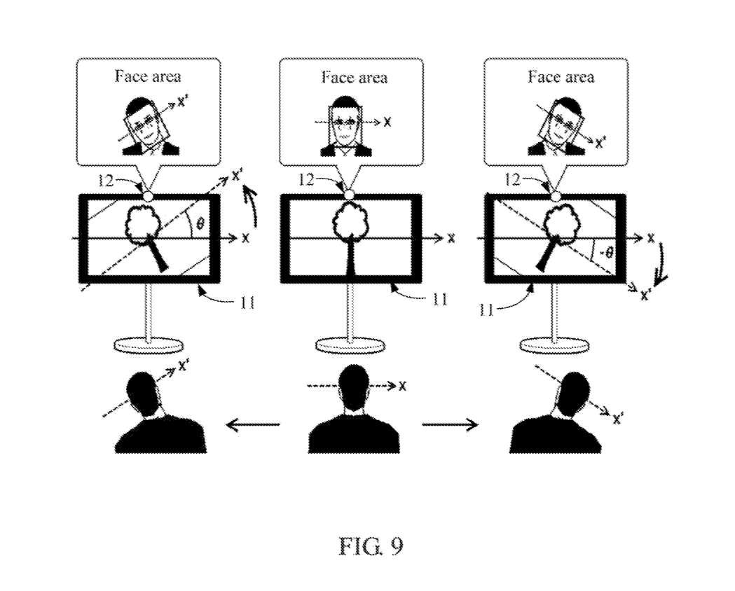

In step S38, the display regulating module 104 adjusts a display angle and a display direction of an image displayed on the display screen 11 to the regulating angle and the regulating direction according to the preset adjustment mode. In the embodiment, the display regulating module 104 adjusts a physical orientation of the display screen 11 (shown in FIG. 8) according to the regulating angle and the regulating direction if the adjustment mode is set as the hardware adjustment mode. The display regulating module 104 adjusts a display orientation of the displayed image on the display screen 11 (shown in FIG. 9) according to the regulating angle and the regulating direction if the adjustment mode is set as the software adjustment mode. As such, the display angle of the image on the display screen 11 is consistent with a viewing angle of the user. The adjustment operation of the display screen 11 or the displayed image is performed in an X-Z plane of the display screen 11 or the displayed image.

FIG. 8 shows a schematic diagram illustrating one embodiment of adjusting a physical orientation of the display screen 11. If the preset adjustment mode is the hardware adjustment mode, the display regulating module 104 orientates or re-orientates (i.e., rotates) the display screen 11 through the determined regulating angle (e.g., thirty degrees) according to the determined regulating direction of the display screen 11, such that a line between the eyes is parallel to (or nearly parallel to) a display direction of the display screen 11. That is, the viewing angle of the user is consistent with the display angle of the image displayed on the display screen 11. In one embodiment, the display regulating module 104 controls the display screen 11 to rotate using the driving unit 13 of the electronic device 1. For example, as shown in FIG. 8, if the regulating angle of the display screen 11 is determined as an angle θ, the display screen 11 is rotated through the angle θ and the displayed image on the display screen 11 is not rotated, so that the viewing angle of the user is consistent with the display angle of the image on the display screen 11.

FIG. 9 shows a schematic diagram illustrating one embodiment of adjusting a display orientation of the displayed image on the display screen 11. If the preset adjustment mode is the software adjustment mode, the display regulating module 104 rotates the displayed image on the display screen 11 through the determined regulating angle (e.g., thirty degrees) according to the determined regulating direction, such that the line between the eyes is parallel to (or nearly parallel to) a display direction of the displayed image on the display screen 11. That is, the viewing angle of the user is consistent with the display angle of the image displayed on the display screen 11. For example, as shown in FIG. 9, if the regulating angle of the displayed image on the display screen 11 is also determined as an angle θ, the displayed image on the display screen 11 is rotated through the angle θ and the display screen 11 is not physically moved or rotated, so that the viewing angle of the user is consistent with the angle of display of the displayed image on the display screen 11.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display screen, an image capturing unit, and at least one processor; and
a storage device storing a computer-readable program comprising instructions that, which when executed by the at least one microprocessor, cause the at least one microprocessor to:
set an initial direction and an initial angle of a user viewing the display screen through a user setting interface displayed on the display screen, and set an adjustment mode of the display screen through the user setting interface;
control the image capturing unit to capture an image of a scene in front of the display screen when the user presses a regulation button of a remote controller;
identify a face area of the user from the scene image according to facial characteristics, and identify a position of eyeballs of the user from the face area of the user according to the eyeball characteristics;
detect a viewing angle and a viewing direction of the user viewing the display screen according to the position of the eyeballs;
compare the initial angle with the viewing angle of the user, and compare the initial direction with the viewing direction of the user;
determine a regulating angle and a regulating direction related to the display screen according to the viewing angle and the viewing direction of the user when the viewing angle is not equal to the initial angle; and
adjust a display angle and a display direction of an image displayed on the display screen to the regulating angle and the regulating direction according to the adjustment mode.

2. The electronic device according to claim 1, wherein the image capturing unit is positioned on a center of a top edge of a front panel of the display screen, and captures images of the scene in front of the display screen.

3. The electronic device according to claim 1, further comprising a driving unit that is positioned on the back or the bottom of the electronic device, and controls the display screen to rotate automatically according to movements of a user's head.

4. The electronic device according to claim 1, wherein the adjustment mode is a hardware adjustment mode for adjusting a physical orientation of the display screen, or a software adjustment mode for adjusting a display orientation of the displayed image on the display screen.

5. The electronic device according to claim 4, wherein the display screen is rotated through the regulating angle according to the regulating direction and the displayed image on the display screen is not rotated, if the adjustment mode is the hardware adjustment mode.

6. The electronic device according to claim 4, wherein the displayed image on the display screen is rotated through the regulating angle according to the regulating direction and the display screen is not rotated, if the adjustment mode is the software adjustment mode.

7. A method for regulating images displayed on a display screen of an electronic device, the electronic device comprising an image capturing unit, the method comprising:
setting an initial direction and an initial angle of a user viewing the display screen through a user setting interface displayed on the display screen, and setting an adjustment mode of the display screen through the user setting interface;
controlling the image capturing unit to capture an image of a scene in front of the display screen when the user presses a regulation button of a remote controller;
identifying a face area of the user from the scene image according to facial characteristics, and identifying a position of eyeballs of the user from the face area of the user according to the eyeball characteristics;
detecting a viewing angle and a viewing direction of the user viewing the display screen according to the position of the eyeballs;
comparing the initial angle with the viewing angle of the user, and comparing the initial direction with the viewing direction of the user;
determining a regulating angle and a regulating direction related to the display screen according to the viewing angle and the viewing direction of the user when the viewing angle is not equal to the initial angle; and
adjusting a display angle and a display direction of an image displayed on the display screen to the regulating angle and the regulating direction according to the adjustment mode.

8. The method according to claim 7, wherein the image capturing unit is positioned on a center of a top edge of a front panel of the display screen, and captures images of the scene in front of the display screen.

9. The method according to claim 7, wherein the electronic device further comprises a driving unit that is positioned on the back or the bottom of the electronic device, and controls the display screen to rotate automatically according to movements of a user's head.

10. The method according to claim 7, wherein the adjustment mode is a hardware adjustment mode for adjusting a physical orientation of the display screen, or a software adjustment mode for adjusting a display orientation of the displayed image on the display screen.

11. The method according to claim 10, wherein the display screen is rotated through the regulating angle according to the regulating direction and the displayed image on the display screen is not rotated, if the adjustment mode is the hardware adjustment mode.

12. The method according to claim 10, wherein the displayed image on the display screen is rotated through the regulating angle according to the regulating direction and the display screen is not rotated, if the adjustment mode is the software adjustment mode.

13. A non-transitory storage medium having instructions, when executed by at least one processor of an electronic device, stored thereon that cause the processor to perform a method for regulating images displayed on a display screen of the electronic device, the electronic device comprising an image capturing unit, the method comprising:
setting an initial direction and an initial angle of a user viewing the display screen through a user setting interface displayed on the display screen, and setting an adjustment mode of the display screen through the user setting interface;
controlling the image capturing unit to capture an image of a scene in front of the display screen when the user presses a regulation button of a remote controller;
identifying a face area of the user from the scene image according to facial characteristics, and identifying a position of eyeballs of the user from the face area of the user according to the eyeball characteristics;
detecting a viewing angle and a viewing direction of the user viewing the display screen according to the position of the eyeballs;
comparing the initial angle with the viewing angle of the user, and comparing the initial direction with the viewing direction of the user;
determining a regulating angle and a regulating direction related to the display screen according to the viewing angle and the viewing direction of the user when the viewing angle is not equal to the initial angle; and
adjusting a display angle and a display direction of an image displayed on the display screen to the regulating angle and the regulating direction according to the adjustment mode.

14. The storage medium according to claim 13, wherein the image capturing unit is positioned on a center of a top edge of a front panel of the display screen, and captures images of the scene in front of the display screen.

15. The storage medium according to claim 13, wherein the electronic device further comprises a driving unit that is positioned on the back or the bottom of the electronic device, and controls the display screen to rotate automatically according to movements of a user's head.

16. The storage medium according to claim 13, wherein the adjustment mode is a hardware adjustment mode for adjusting a physical orientation of the display screen, or a software adjustment mode for adjusting a display orientation of the displayed image on the display screen.

17. The storage medium according to claim 16, wherein the display screen is rotated through the regulating angle according to the regulating direction and the displayed image on the display screen is not rotated, if the adjustment mode is the hardware adjustment mode.

18. The storage medium according to claim 16, wherein the displayed image on the display screen is rotated through the regulating angle according to the regulating direction and the display screen is not rotated, if the adjustment mode is the software adjustment mode.
